(19) United States
(12) Patent Application Publication
(10) Pub. No.: US 2012/0019717 A1
(43) Pub. Date: Jan. 26, 2012

(54) CREDIT INFORMATION SEGMENT DETECTION METHOD, CREDIT INFORMATION SEGMENT DETECTION DEVICE, AND CREDIT INFORMATION SEGMENT DETECTION PROGRAM

(75) Inventor: Ryota Mase, Tokyo (JP)

(73) Assignee: NEC CORPORATION, Tokyo (JP)

(21) Appl. No.: 13/143,500

(22) PCT Filed: Dec. 21, 2009
(86) PCT No.: PCT/JP2009/007048

§ 371 Date: Jul. 6, 2011

(30) Foreign Application Priority Data
Jan. 6, 2009 (JP) 2009-001172

(51) Int. Cl. H04N 7/00

(52) U.S. Cl. 348/468; 348/E07.033

(57) ABSTRACT

A credit information segment detection device is equipped with: an input means which inputs the video data of video content; a search starting point determination means which, based on the probability that a credit information high-text-density part wherein text is displayed with a high density exists in a credit display segment, determines a starting point that indicates a time position for starting a credit information search process; and a display segment judgment means which, after the credit information search process with respect to the starting point has been performed, determines a credit information display segment by expanding the segment during which the search process is performed before and after the starting point.

### TECHNICAL FIELD

The present invention relates to a credit-title segment detection method, a credit-title segment detection device and a credit-title segment detection program for detecting a segment of credit title (e.g., telop for displaying the copyright holder, cast, etc.). In particular, the present invention relates to a credit-title segment detection method, a credit-title segment detection device and a credit-title segment detection program that realize high speed and high accuracy of the detection/recognition of the credit title superimposed on video content.

### BACKGROUND ART

For the detection and recognition of the telop superimposed on video content, there have been proposed numbers of techniques focusing on features (e.g., edge components) extracted from a part of each frame image around the telop and the display duration of the telop.

Patent Literature 1 discloses a telop information display device which automatically extracts a fixed telop (which does not move on the screen) from video. The telop detection method employed for the telop information display device of the Patent Literature 1 includes two methods: a method for at all frames of the inputted video and a method for exclusively at frames sampled according to prescribed rules. In either case, edge images generated by executing edge detection to sampled images, respectively, are binarized and thereafter the extraction process for extracting the fixed telop is conducted by narrowing down a candidate area (in which the telop can exist) by use of a motionless edge image obtained by calculating the logical product of the binarized images. In this detection method, the detection process is carried out from the opening of the video even when a telop exists in the final phase of the video content or telops exists in the final phase of the video content in high concentration.

Patent Literature 2 discloses an in-video credit character detection method for detecting characters (letters) of credits which are displayed on the screen while moving. In the in-video credit character detection method of the Patent Literature 2, frame images are acquired from the video at preset time segments. Feature points characteristically appearing in a character-displaying part of the screen are detected from each of the acquired frame images and thereafter the appearance of credit characters in each frame image is detected based on spatial distribution of the detected feature points. The feature points of a frame image (in which the appearance of credit characters has been detected) are then compared with the feature points of a subsequently acquired frame image, thereby calculating the moving distance (moving speed) of all the credits. Based on the calculated moving distance, coordinate values of one frame image are transformed so that all credits (displayed in common in both frame images) in the frame image spatially overlap the credits in the other frame image, thereby detecting the credit characters. Also in this detection method (similarly to the detection method employed for the telop information display device of the Patent Literature 1), the detection process is carried out from the opening of the video even when telops exists in the final phase of the video content in high concentration. Further, in this detection method, the same detection process is executed even when the density of credit characters displayed in the frame image changes considerably.

### PRIOR ART LITERATURE

### Patent Literature

Patent Literature 1 JP-A-2001-285716
Patent Literature 2 Japanese Patent No. 3439105

### SUMMARY OF THE INVENTION

### Problem to be Solved by the Invention

In the telop detection method described in the Patent Literature 1 and the credit detection method described in the Patent Literature 2, the detection is carried out in order of the time series by taking advantage of the nature of the telop/credit that the characters are displayed continuously for a certain time period. If these methods are used for detecting the credit titles (corresponding to the telop for displaying the copyright holder, cast, etc.) from video content of a broadcast program, it takes a long time for the detection process since the search for the credit titles, having a high probability of appearing in the final phase of the program, is carried out from the opening of the program. Further, since any types of telops are detected as targets of the detection, it is impossible to separate the credit title from the detected telops. Furthermore, in the telop detection process executed uniformly by use of the same parameters, the telop detection tends to fail in the initial phase or final phase of the credit title where the character string density is low, involving the possibility of failing to detect the credit titles.

It is therefore the primary object of the present invention to provide a credit-title segment detection method, a credit-title segment detection device and a credit-title segment detection program capable of reducing the processing time for the detection of the credit titles and also realizing the selective detection of the credit titles alone with high accuracy.

### Means for Solving the Problem

A credit-title segment detection device in accordance with an exemplary aspect of the invention is a device for detecting a display segment of credit title from video content. The credit-title segment detection device comprises: an input unit for inputting video data of the video content; a search starting point determination unit for determining a starting point which represents a temporal position for starting a credit-title search process based on an existence probability of a high character density part of the credit title in which characters are displayed with high density in the credit-title segment; and a display segment judgment unit for judging the display segment of the credit title by first executing the credit-title search process to the starting point and thereafter successively extending a segment as the target of the search process forward and backward from the starting point.

A credit-title segment detection method in accordance with an exemplary aspect of the invention is a method for detecting a display segment of credit title from video content. The credit-title segment detection method comprises the steps of: inputting video data of the video content; determining a starting point which represents a temporal position for starting a credit-title search process based on an existence probability of a high character density part of the credit title in which characters are displayed with high density in the credit-title segment; and judging the display segment of the credit title by first executing the credit-title search process to the starting point and thereafter successively extending a segment as the target of the search process forward and backward from the starting point.

A credit-title segment detection program in accordance with an exemplary aspect of the invention causes a computer for a credit-title segment detection device, for detecting a display segment of credit title from video content, to execute a process comprising the steps of: inputting video data of the video content; determining a starting point which represents a temporal position for starting a credit-title search process based on an existence probability of a high character density part of the credit title in which characters are displayed with high density in the credit-title segment; and judging the display segment of the credit title by first executing the credit-title search process to the starting point and thereafter successively extending a segment as the target of the search process forward and backward from the starting point.

### Advantageous Effects of Invention

By the present invention, the process of detecting the credit titles superimposed on video content can be speeded up and the accuracy of the credit-title detection process can be increased.

### BRIEF DESCRIPTION OF THE DRAWINGS

FIG. 1 It depicts a block diagram showing the general configuration of a first exemplary embodiment of a credit-title segment detection device in accordance with the present invention.

FIG. 2 It depicts a flow chart showing a process executed by the credit-title segment detection device shown in FIG. 1.

FIG. 3 It depicts a block diagram showing an example of the configuration of a credit-title search starting point determination unit.

FIG. 4 It depicts a block diagram showing another example of the configuration of the credit-title search starting point determination unit.

FIG. 5 It depicts a block diagram showing an example of the configuration of a credit-title segment judgment unit.

FIG. 6 It depicts a block diagram showing an example of the configuration of a high confident segment including credit title detection unit.

FIG. 7 It depicts a flow chart showing an example of the operation of the high confident segment including credit title detection unit.

FIG. 8 It depicts a flow chart showing a process for determining a starting point of a high confident segment including credit title.

FIG. 9 It depicts a flow chart showing a process for determining an ending point of the high confident segment including credit title.

FIG. 10 It depicts a block diagram showing an example of the configuration of a credit-title segment starting/ending point detection unit.

FIG. 11 It depicts a block diagram showing another example of the configuration of the credit-title segment starting/ending point detection unit.

FIG. 12 It depicts a block diagram showing the general configuration of a second exemplary embodiment of the credit-title segment detection device in accordance with the present invention.

FIG. 13 It depicts a block diagram showing an example of the configuration of a credit-title search starting point determination unit shown in FIG. 12.

FIG. 14 It depicts a block diagram showing another example of the configuration of the credit-title search starting point determination unit shown in FIG. 12.

FIG. 15 It depicts a block diagram showing an example of the configuration of a header information analysis unit.

FIG. 16 It depicts a block diagram showing another example of the configuration of the header information analysis unit.

FIG. 17 It depicts a block diagram showing the principal part of the credit-title segment detection device in accordance with the present invention.

### MODE FOR CARRYING OUT THE INVENTION

### First Exemplary Embodiment

A first exemplary embodiment (exemplary embodiment 1) of a credit-title segment detection device in accordance with the present invention will be described below with reference to figures.

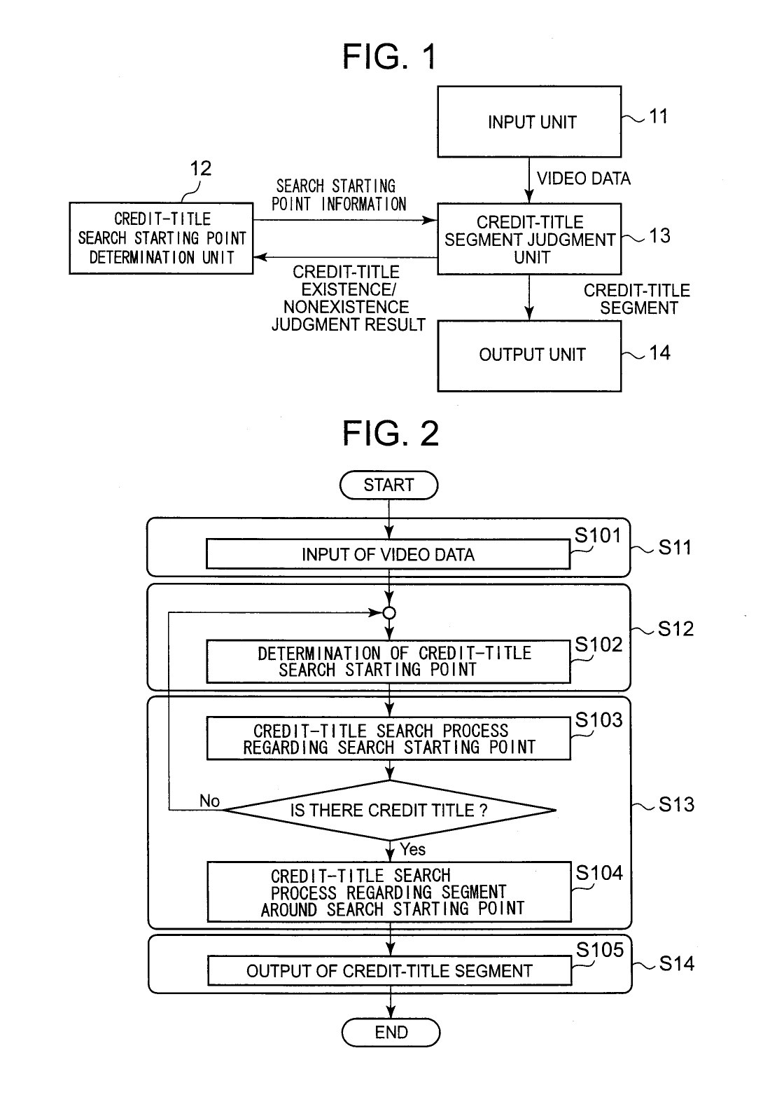

FIG. 1 is a block diagram showing the general configuration of the first exemplary embodiment of the credit-title segment detection device in accordance with the present invention. The credit-title segment detection device of the first exemplary embodiment includes an input unit 11, a credit-title search starting point determination unit 12, a credit-title segment judgment unit 13 and an output unit 14. The input unit 11 inputs image data as the target of processing to the credit-title segment judgment unit 13. The credit-title search starting point determination unit 12 determines a starting point which represents a temporal position for starting a credit-title search process. The credit-title segment judgment unit 13 executes the search process to the search starting point determined by the credit-title search starting point determination unit 12. When no credit titles exist at the search starting point, the credit-title segment judgment unit 13 returns the judgment result to the credit-title search starting point determination unit 12. When a credit title exists at the search starting point, the credit-title segment judgment unit 13 extends the target of the search process forward and backward from the search starting point and thereby judges the display segment of the credit title. The output unit 14 outputs the result of the judgment on the credit-title segment.

At the input unit 11, compressed video or video obtained by decoding compressed video is inputted as video data. When compressed video is inputted, any compression format (MPEG, H.264, MJPEG (Motion JPEG), WMV (Windows® Media Video), RealVideo, etc.) may be used for the compression (encoding) as long as the decoding is possible.

When the credit-title search process is executed to the video data inputted from the input unit 11, the credit-title search starting point determination unit 12 determines the starting point of the search process and outputs information representing the search starting point to the credit-title segment judgment unit 13. When a judgment result indicating that there exists no credit-title segment is returned from the credit-title segment judgment unit 13, the credit-title search starting point determination unit 12 determines the search starting point again. The credit-title search starting point determination unit 12 is implemented by, for example, a CPU loaded with a program operating according to preset rules. The details of the credit-title search starting point determination unit 12 will be described later.

The credit-title segment judgment unit 13 executes the search process to the video data inputted from the input unit 11 in regard to the search starting point determined by the credit-title search starting point determination unit 12. When the credit title is found, the credit-title segment judgment unit 13 judges the credit-title segment by extending the target of the search process forward and backward from the search starting point, and outputs information on the display segment (e.g., a start frame and an end frame) to the output unit 14. In contrast, when no credit titles are found, the credit-title segment judgment unit 13 returns the judgment result to the credit-title search starting point determination unit 12 and thereafter makes the credit-title segment judgment in regard to a search starting point determined again. The credit-title segment judgment unit 13 is implemented by, for example, a CPU loaded with a program operating according to preset rules. The details of the credit-title segment judgment unit 13 will be described later.

When the credit title is judged to exist by the credit-title segment judgment unit 13, the output unit 14 outputs the information on the display segment of the credit title. For example, when the credit-title segment detection method in accordance with the present invention is implemented as a program and the information on the display segment is supplied to a program for executing a subsequent process via a memory, the output unit 14 outputs the information on the display segment to the memory.

FIG. 2 is a flow chart showing a process executed by the credit-title segment detection device shown in FIG. 1. The general outline of the process executed by the credit-title segment detection device of FIG. 1 will be explained referring to FIG. 2.

In step S11, the video data is inputted from the input unit 11 (step S101). In step S12, the starting point representing the temporal position for starting the credit-title search process is determined by the credit-title search starting point determination unit 12 (step S102).

In step S13, the credit-title segment judgment unit 13 judges whether or not the credit title exists at the starting point (step S103). When no credit titles exist in the step S103, the credit-title segment judgment unit 13 informs the credit-title search starting point determination unit 12 of the judgment result. In this case, the credit-title search starting point determination unit 12 determines the credit-title search starting point again (step S102). When the credit title exists in the step S103, the credit-title segment judgment unit 13 determines credit-title starting/ending points by extending the range of the search forward and backward from the search starting point (step S104).

In step S14 after the determination of the credit-title starting/ending points in the step S104, the output unit 14 outputs the information on the credit-title segment (step S104), by which the process is ended.

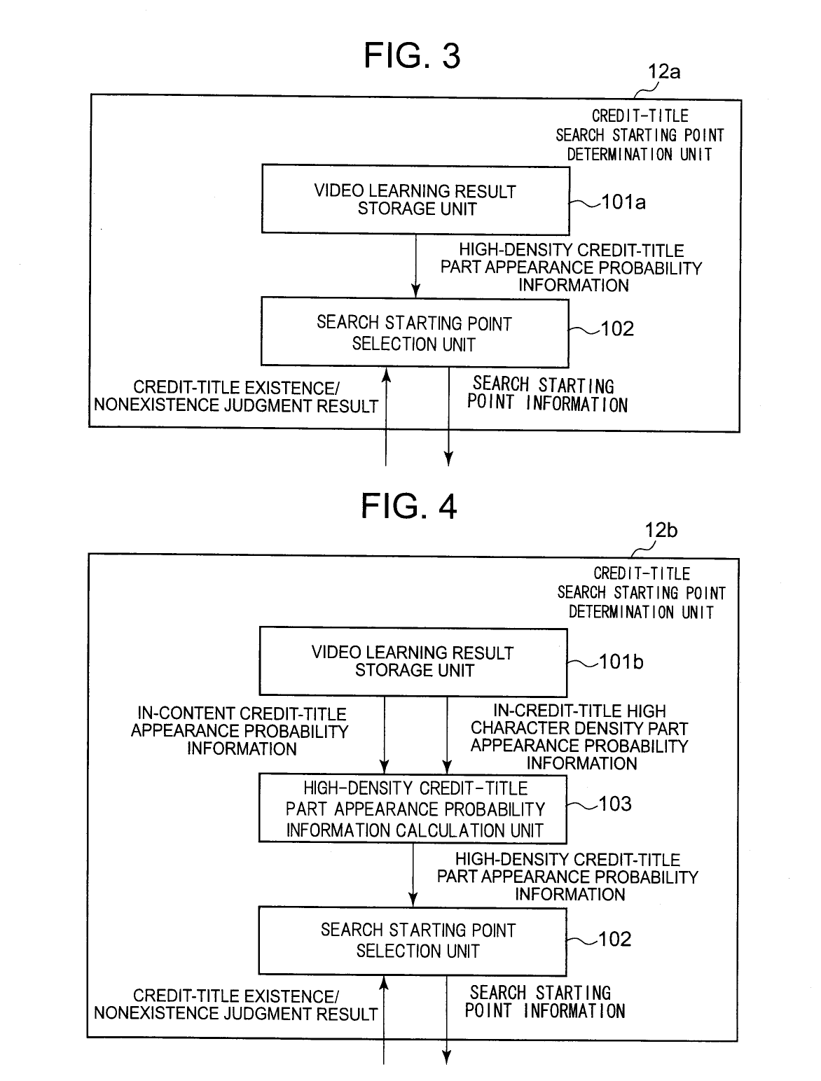

FIGS. 3 and 4 are block diagrams showing examples of the configuration of the credit-title search starting point determination unit. Credit-title search starting point determination units 12a and 12b as the configuration examples of the credit-title search starting point determination unit 12 will be explained below referring to FIGS. 3 and 4.

The credit-title search starting point determination unit 12a shown in FIG. 3 includes a video learning result storage unit 101a and a search starting point selection unit 102. The video learning result storage unit 101a stores information on properties of the credit title obtained by learning a plurality of programs. Especially, the video learning result storage unit 101a shown in FIG. 3 accumulates high-density credit-title part appearance probability information which is estimated by acquiring temporal position information (regarding temporal positions where the density of characters (letters) of the credit title increases) from a large number of programs by viewing the programs (visual recognition), for example. In cases where the learning of the programs is conducted by a method other than the visual recognition, temporal segments of the displaying of the credit title in each program and the character density in the temporal segments may be estimated based on the result of telop detection in each program by an already-existing telop detection method, for example. The information accumulated in the video learning result storage unit 101a may be acquired separately for each type of credit titles (vertically moving credit titles, horizontally moving credit titles, etc.) and switched depending on the type of credit title.

In the credit-title search starting point determination unit 12a, the search starting point selection unit 102 reads out the high-density credit-title part appearance probability information from the video learning result storage unit 101a, determines the search starting point based on the information, and outputs information representing the search starting point to the credit-title segment judgment unit 13. For example, a temporal position (frame) where the probability value in the distribution of the high-density credit-title part appearance probability reaches the maximum is determined as the search starting point. The credit-title segment judgment unit 13 judges whether or not the credit title exists at the search starting point.

When a judgment result indicating that no credit titles exist at the search starting point is returned from the credit-title segment judgment unit 13, the search starting point selection unit 102 redetermines the search starting point as, for example, another temporal position (frame) where the probability value in the distribution of the high-density credit-title part appearance probability reaches the maximum among temporal positions other than the starting point already selected once. Then, the search starting point selection unit 102 outputs information indicating the search starting point to the credit-title segment judgment unit 13. In this case, the redetermination of the search starting point may be made excluding temporal positions in the vicinity of the starting point already selected once.

Incidentally, the credit-title search starting point determination unit 12a may also determine the search starting point not as a particular temporal position (frame) but as a search start segment having a temporal width. In this case, the search starting point selection unit 102 gradually shifts a window (having a certain width) with respect to the distribution of the high-density credit-title part appearance probability, for example. The search starting point selection unit 102 integrates the probability value in each window frame and determines a window region that maximizes the integrated value as the search start segment. When a judgment result indicating that no credit titles exist in the search start segment is returned from the credit-title segment judgment unit 13, the search starting point selection unit 102 redetermines the search start segment as another window region maximizing the integrated value (of the probability value in a window frame) among windows other than the window already selected once, and outputs information representing the search start segment to the credit-title segment judgment unit 13. Alternatively, the search starting point selection unit 102 may also consider a point where the probability value in the distribution of the high-density credit-title part appearance probability reaches a local maximum and determine the search start segment as a temporal region having a certain width around the local maximum point. The search starting point selection unit 102 may also determine the search start segment as a continuous segment in which the appearance probability remains greater than or equal to a prescribed value.

Meanwhile, the credit-title search starting point determination unit 12b shown in FIG. 4 includes a video learning result storage unit 101b, a search starting point selection unit 102 and a high-density credit-title part appearance probability information calculation unit 103. The function of the search starting point selection unit 102 in FIG. 4 is similar to that of the search starting point selection unit 102 in FIG. 3, and thus detailed explanation thereof is omitted.

The video learning result storage unit 101b stores in-content credit-title appearance probability information and in-credit-title high character density part appearance probability information. The in-content credit-title appearance probability information is estimated by acquiring starting/ending temporal positions of the displaying of the credit title from a large number of programs by visual recognition, for example. The in-content credit-title appearance probability information is information indicating the probability of appearance of a point (in time) representing a particular position in the credit title. The in-content credit-title appearance probability information can be acquired using starting points of multiple pieces of credit title, for example. It is also possible to use predetermined arbitrary points (ending points, midpoints, etc.) instead of the starting points. Meanwhile, the in-credit-title high character density part appearance probability information is estimated by acquiring the changes in the character density in the segment displaying the credit title from a large number of programs by visual recognition, for example. The in-credit-title high character density part appearance probability information is information indicating the probability of appearance of a point (in time) at which characters are displayed with high density in the credit-title segment. The in-credit-title high character density part appearance probability information can also be acquired from a large number of pieces of program data. When the length of the temporal segment displaying the credit title (frame duration of a chunk of credit title formed by consecutive frames) varies, the in-credit-title high character density part appearance probability information may be determined by normalizing the length of the credit title. The normalization of the credits can be implemented by, for example, mapping the length of the credit-title sequence (varying depending on the program data) into a unit time length. The information stored in the video learning result storage unit 101b may be acquired separately for each type of credit titles (vertically moving credit titles, horizontally moving credit titles, etc.) and switched depending on the type of credit title.

The high-density credit-title part appearance probability information calculation unit 103 reads out the in-content credit-title appearance probability information and the in-credit-title high character density part appearance probability information from the video learning result storage unit 101b. The high-density credit-title part appearance probability information calculation unit 103 calculates high-density credit-title part appearance probability information by overlaying the in-credit-title high character density part appearance probability information on the in-content credit-title appearance probability information as a window function, for example. Alternatively, the high-density credit-title part appearance probability information calculation unit 103 may also read out the in-content credit-title appearance probability information alone from the video learning result storage unit 101b and calculate the high-density credit-title part appearance probability information by assuming that the in-credit-title high character density part appearance probability has the peak of its distribution substantially at the center of the credit-title segment.

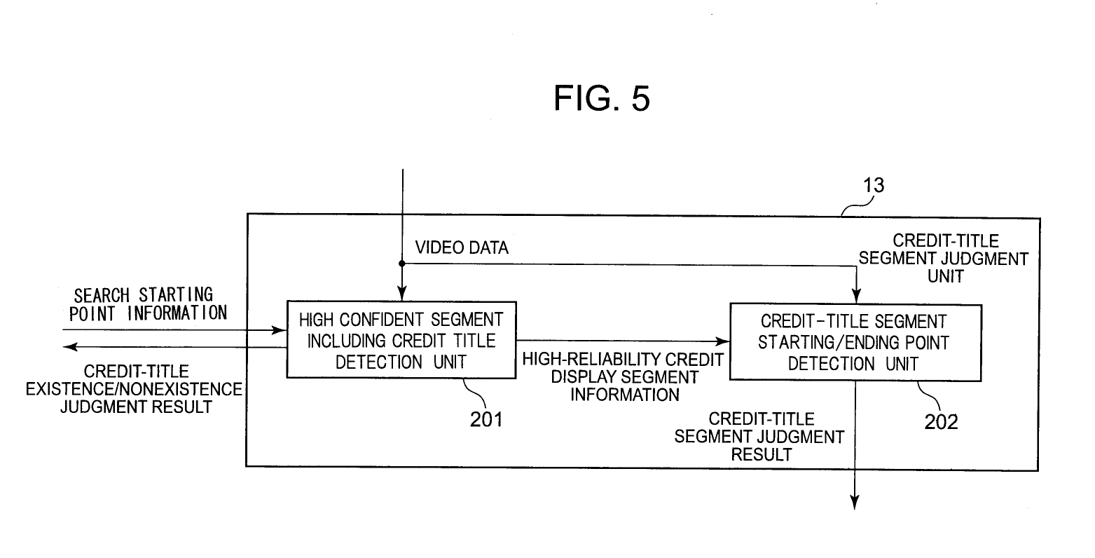

Next, the credit-title segment judgment unit 13 will be explained in detail. FIG. 5 is a block diagram showing an example of the configuration of the credit-title segment judgment unit. The credit-title segment judgment unit 13 shown in FIG. 5 includes a high confident segment including credit title detection unit 201 and a credit-title segment starting/ending point detection unit 202.

The high confident segment including credit title detection unit 201 is supplied with the video data inputted from the input unit 11 and the search starting point information inputted from the credit-title search starting point determination unit 12. The high confident segment including credit title detection unit 201 considers an analysis window including the search starting point and having a certain temporal width and makes a judgment on the existence/nonexistence of the credit title by use of frames in the analysis window. When the credit title is judged to exist by this judgment, the high confident segment including credit title detection unit 201 advances to a high-reliability credit-title search process. The high-reliability credit-title search process is a process for determining a segment that is judged to contain a credit title with high reliability.

Specifically, the high confident segment including credit title detection unit 201 successively shifts the analysis window forward and backward in time from the original position of the analysis window and further makes a judgment on the existence/nonexistence of credit title at each analysis window position. In this case, a segment that is formed by connecting analysis windows in which credit title is judged to be displayed is regarded as a segment in which the credit title is displayed with high reliability, and information representing the segment is outputted as high-reliability credit-title segment information. When no credit titles are judged to exist at the analysis window position in the first judgment, the high confident segment including credit title detection unit 201 returns the judgment result to the credit-title search starting point determination unit 12.

In the case where the information inputted from the credit-title search starting point determination unit 12 is not a search starting point representing a particular temporal position (frame) but a search start segment having a temporal width, the high confident segment including credit title detection unit 201 checks whether a valid search starting point exists in the search start segment, that is, whether a credit title actually exists in the search start segment. The method for the judgment on the existence/nonexistence of credit title is similar to that in the case where a search starting point is inputted. Upon finding a valid search starting point, the high confident segment including credit title detection unit 201 advances to the high-reliability credit-title search process. The subsequent process is similar to that in the case where a search starting point is inputted from the credit-title search starting point determination unit 12. When no valid search starting point is judged to exist in the search start segment, the high confident segment including credit title detection unit 201 returns the judgment result to the credit-title search starting point determination unit 12.

Incidentally, a judgment on the existence/nonexistence of credit title is made in the credit-title search process executed by the high confident segment including credit title detection unit 201. The judgment process can be implemented by use of, for example, the continuity of frames judged to be displaying a telop and the ratio of the number of such frames in the case where the telop detection process is executed to frames in the analysis window as the target of the search process. The telop detection process can be executed employing various conventional telop detection methods. In this case, high fineness/accuracy is not required of the telop detection in consideration of the fact that the segment in which the analysis window is placed has originally been determined assuming a high character density. Further details of the high confident segment including credit title detection unit 201 will be explained later.

The credit-title segment starting/ending point detection unit 202 is supplied with the video data inputted from the input unit 11 and the high-reliability credit-title segment information inputted from the high confident segment including credit title detection unit 201. The credit-title segment starting/ending point detection unit 202 detects a starting point and an ending point of the credit-title segment by successively extending the target of the search process forward and backward from the high confident segment including credit title in the video data. Thereafter, the credit-title segment starting/ending point detection unit 202 outputs the information on the credit-title segment obtained by the search process. For example, the credit-title segment starting/ending point detection unit 202 outputs only a start frame number and an end frame number of the credit-title segment. Further details of the credit-title segment starting/ending point detection unit 202 will be explained later.

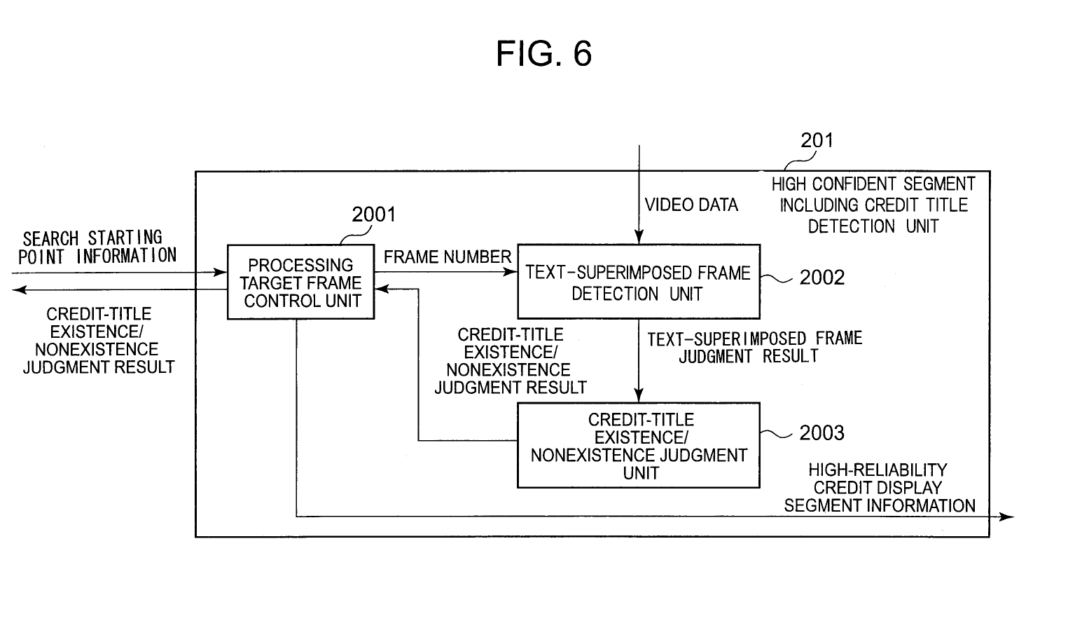

FIG. 6 is a block diagram showing an example of the configuration of the high confident segment including credit title detection unit. The high confident segment including credit title detection unit 201 will be explained in detail below referring to FIG. 6.

The high confident segment including credit title detection unit 201 includes a processing target frame control unit 2001, a text-superimposed frame detection unit 2002 and a credit-title existence/nonexistence judgment unit 2003.

The processing target frame control unit 2001 receives a search starting point representing a particular temporal position (frame) or a search start segment having a temporal width from the credit-title search starting point determination unit 12. When the information inputted from the credit-title search starting point determination unit 12 is a search starting point representing a particular temporal position (frame), the processing target frame control unit 2001, taking advantage of the nature of the credit-title segment being in many cases longer than other telop display segments, determines a frame analysis window having a certain width in a segment containing the search starting point. The processing target frame control unit 2001 selects a frame as the target of the telop detection process from the frames contained in the determined analysis window and outputs the frame number of the selected frame to the text-superimposed frame detection unit 2002.

When the information inputted from the credit-title search starting point determination unit 12 is a search start segment having a temporal width, the processing target frame control unit 2001 selects a frame as the target of the telop detection process from a set of frames contained in the analysis window by regarding each frame position in the search start segment as the search starting point. Thereafter, the processing target frame control unit 2001 outputs the frame number of the selected frame to the text-superimposed frame detection unit 2002. The selection of the frame as the processing target may be made from the forefront frame of the set of frames in order of the time series or from the final frame of the set of frames in the inverse temporal direction, for example.

The text-superimposed frame detection unit 2002 is supplied with the video data inputted from the input unit 11 and the frame number inputted from the processing target frame control unit 2001. The text-superimposed frame detection unit 2002 judges whether a telop is displayed in the frame having the frame number in the inputted video data or not and outputs the judgment result to the credit-title existence/nonexistence judgment unit 2003. For example, the text-superimposed frame detection unit 2002 first generates a frame image of the frame having the frame number in the video data. When the video data is compressed video, the text-superimposed frame detection unit 2002 constructs the frame image by decoding data corresponding to the frame number. Subsequently, the text-superimposed frame detection unit 2002 generates a frame edge image by applying an edge detection filter (two-dimensional Laplacian filter, Canny filter, etc.) to the generated frame image. The frame edge image generated here is an image which indicates a telop existence candidate area since a lot of edge components are obtained by calculation from the part where the telop exists. The text-superimposed frames are detected by use of the frame edge images. In the detection of the text-superimposed frames, an edge pair feature quantity which is used in the in-video credit character detection method described in the Patent Literature 2 may also be employed. In this case, the detection process may be executed in either temporal direction from the starting point of the process.

The credit-title existence/nonexistence judgment unit 2003 receives the text-superimposed frame detection result from the text-superimposed frame detection unit 2002. The credit-title existence/nonexistence judgment unit 2003 judges whether the credit title exists or not by checking whether or not text-superimposed frames appear in the analysis window (of the frames determined by the processing target frame control unit 2001) continuously and with a prescribed ratio or higher, whether or not text-superimposed frames exist in the analysis window with a prescribed ratio or higher, etc. Thereafter, the credit-title existence/nonexistence judgment unit 2003 outputs the judgment result to the processing target frame control unit 2001 as a credit-title existence/nonexistence judgment result.

When a judgment result indicating that the credit title exists is outputted from the credit-title existence/nonexistence judgment unit 2003 to the processing target frame control unit 2001 as the result of the credit-title search process executed to the frames specified by the search starting point or the search start segment inputted from the credit-title search starting point determination unit 12, the subsequent process is conducted as below. The credit-title existence/nonexistence judgment unit 2003 successively shifts the analysis window forward or backward in time from the original frame position (at the search starting point or in the search start segment) and further makes a judgment on the existence/nonexistence of credit title at each analysis window position. At the point when a judgment result indicating that no credit titles exist is outputted from the credit-title existence/nonexistence judgment unit 2003, the processing target frame control unit 2001 regards a segment formed by connecting the analysis windows that have been judged to display the credit title as a high-reliability credit-title segment and outputs information representing the high-reliability credit-title segment to the credit-title segment starting/ending point detection unit 202 as the high-reliability credit-title segment information.

In contrast, when a judgment result indicating that no credit titles exist is outputted from the credit-title existence/nonexistence judgment unit 2003 to the processing target frame control unit 2001 as the result of the credit-title search process executed to the frames specified by the search starting point or the search start segment inputted from the credit-title search starting point determination unit 12, the processing target frame control unit 2001 sends the judgment result to the credit-title search starting point determination unit 12 as the credit title existence/nonexistence judgment result.

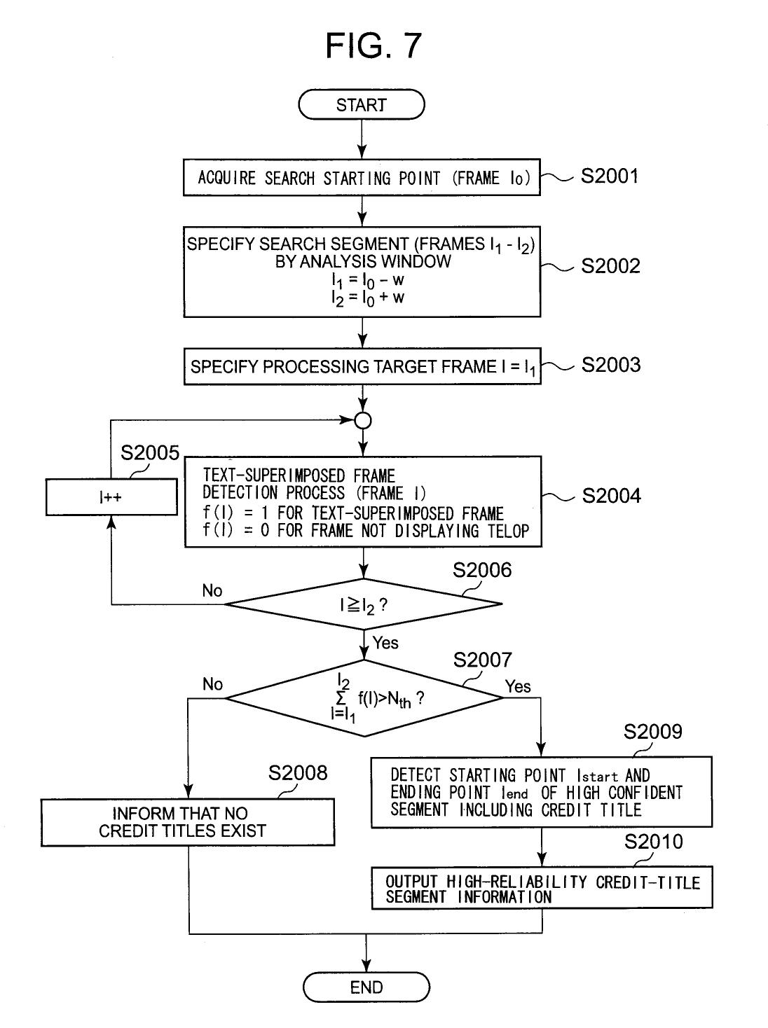

FIG. 7 is a flow chart showing an example of the operation of the high confident segment including credit title detection unit. The example of the operation of the high confident segment including credit title detection unit 201 will be explained below referring to FIG. 7. FIG. 7 shows a case where a search starting point representing a particular temporal position (frame) is inputted to the processing target frame control unit 2001 shown in FIG. 6.

First, the processing target frame control unit 2001 acquires the search starting point (search start frame number: assumed to be “frame I₀”) (step S2001). The processing target frame control unit 2001 sets a frame analysis window having a window width of 2w+1 around the search starting point and specifies the inside of the analysis window (assumed to be frames I₁-I₂) as a search segment (step S2002). Subsequently, the processing target frame control unit 2001 specifies the forefront frame of the search segment specified in the step S2002 (frame I₁) as the first processing target frame (step S2003). The text-superimposed frame detection unit 2002 executes the telop detection process to the processing target frame (step S2004). In this step S2004, whether a telop is displayed in the frame or not is judged and the judgment result f(I) is set at 1 (f(I)=1) when a telop is displayed or at 0 (f(I)=0) when no telop is displayed.

Subsequently, the text-superimposed frame detection unit 2002 shifts the processing target frame (expressed as “I++” in FIG. 7) (step S2005) and executes the same process. When the telop detection process is finished up to the final frame of the search segment (step S2006), that is, when I≧I₂ is satisfied, the credit-title existence/nonexistence judgment unit 2003 judges whether the credit title exists or not by checking whether or not telop detection frames more than a prescribed ratio (Nₜₕ) are included in the search segment (step S2007). When no credit titles are judged to exist, the credit-title existence/nonexistence judgment unit 2003 sends the judgment result to the credit-title search starting point determination unit 12 (step S2008). When the credit title is judged to exist, the credit-title existence/nonexistence judgment unit 2003 detects the starting point (Iₛₜₐᵣₜ) and the ending point (I_{end}) of the segment in which the credit title is displayed with high reliability (step S2009). Thereafter, the credit-title existence/nonexistence judgment unit 2003 outputs the high-reliability credit-title segment information obtained by the detection process to the credit-title segment starting/ending point detection unit 202 (step S2010). A further detailed example of the operation of the step S2009 will be explained later. Incidentally, also when a search start segment having a temporal width is inputted in the step S2001, the process flow of the steps S2002-2010 can be employed without change, by regarding a point in the search start segment as the search starting point in the process of the steps S2002-2010.

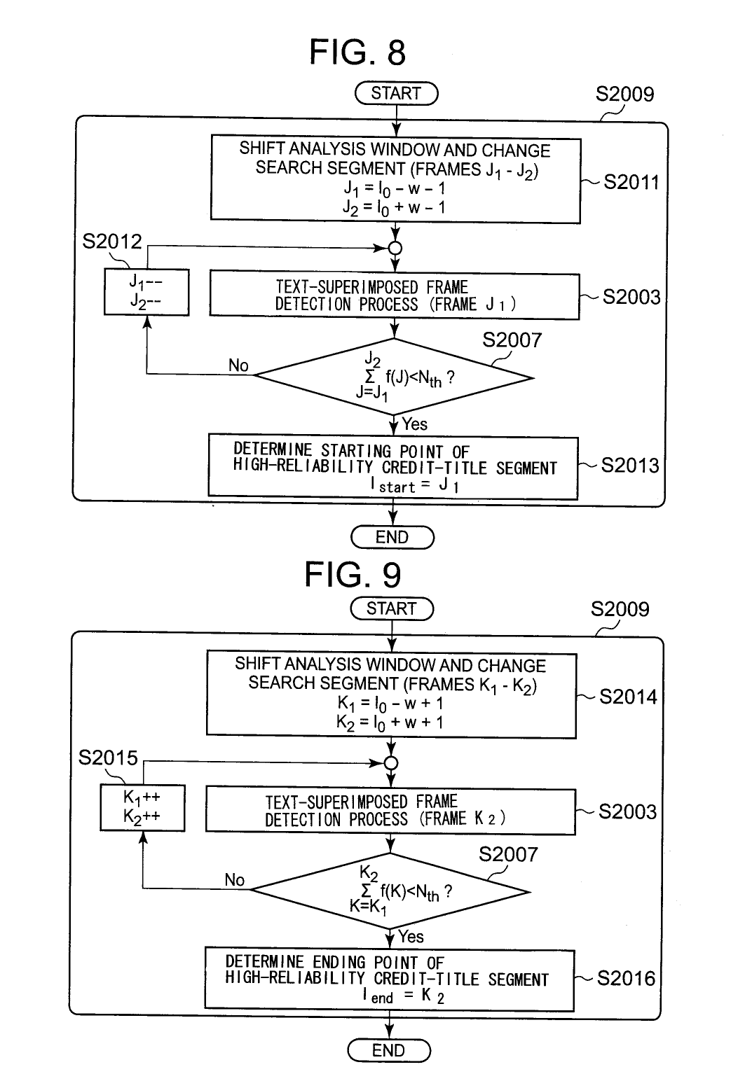

FIG. 8 is a flow chart showing a process for determining the starting point of the high confident segment including credit title included in the step S2009 in FIG. 7.

First, the processing target frame control unit 2001 changes the segment for the credit title existence/nonexistence judgment by shifting the frame analysis window (set in the step S2002 in FIG. 7) forward in time (step S2011). The text-superimposed frame detection unit 2002 executes the text-superimposed frame detection process to the frame (frame J₁) newly added to the analysis window (assumed to be frames J₁-J₂) (step S2003). The credit-title existence/nonexistence judgment unit 2003 makes a judgment on whether the credit title exists or not by checking whether or not telop detection frames more than the prescribed ratio are included in the analysis window (step S2007). When the credit title is judged to exist, the frame analysis window is further shifted forward (expressed as “J₁−−” and “J₂−−” in FIG. 8) (step S2012) and the same process is executed. When no credit titles are judged to exist, the forefront frame of the frame analysis window at this point is determined as the starting point (Iₛₜₐᵣₜ) of the high-reliability credit-title segment. While the forefront frame is determined as the starting point in this example, it is also possible to determine a frame that is a prescribed number of frames apart from the forefront frame as the starting point. For example, it is possible to take a small margin M at the forefront frame by valuing reliability and determine a frame J₁+M as the starting point.

FIG. 9 is a flow chart showing a process for determining the ending point of the high confident segment including credit title included in the step S2009 in FIG. 7.

First, the processing target frame control unit 2001 changes the segment for the credit-title existence/nonexistence judgment by shifting the frame analysis window (set in the step S2002 in FIG. 7) backward in time (step S2014). The text-superimposed frame detection unit 2002 executes the text-superimposed frame detection process to the frame (frame K₂) newly added to the analysis window (step S2003). The credit-title existence/nonexistence judgment unit 2003 makes a judgment on whether the credit title exists or not by checking whether or not telop detection frames more than the prescribed ratio are included in the analysis window (step S2007). When the credit title is judged to exist, the frame analysis window is further shifted backward (expressed as “K₁++” and “K₂++” in FIG. 9) (step S2015) and the same process is executed. When no credit titles are judged to exist, the end frame of the frame analysis window at this point is determined as the ending point of the high-reliability credit-title segment. While the end frame is determined as the ending point in this example, it is also possible to determine a frame that is a prescribed number of frames apart from the end frame as the ending point. For example, it is possible to take a small margin M at the end frame K₂ by valuing reliability and determine a frame K₂-M as the ending point. Either of the processes for determining the starting point and the ending point of the high-reliability credit-title segment (FIG. 8, FIG. 9) may be executed first.

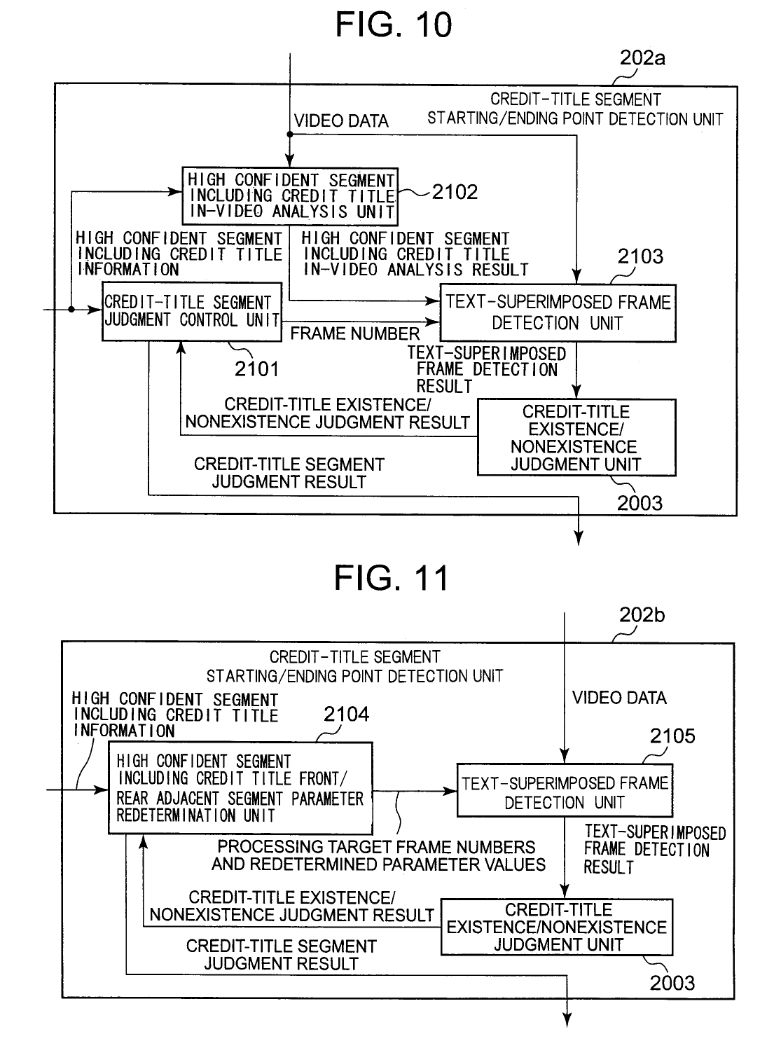

FIGS. 10 and 11 are block diagrams showing examples of the configuration of the credit-title segment starting/ending point detection unit. Credit-title segment starting/ending point detection units 202a and 202b as the configuration examples of the credit-title segment starting/ending point detection unit 202 will be explained below referring to FIGS. 10 and 11.

The credit-title segment starting/ending point detection unit 202a shown in FIG. 10 includes a credit-title segment judgment control unit 2101, a high confident segment including credit title in-video analysis unit 2102, a text-superimposed frame detection unit 2103 and a credit-title existence/nonexistence judgment unit 2003.

The credit-title segment judgment control unit 2101 receives the high-reliability credit-title segment information from the high confident segment including credit title detection unit 201. The credit-title segment judgment control unit 2101 successively selects processing target frames starting from a frame adjoining the starting point or ending point of the high confident segment including credit title specified by the high-reliability credit-title segment information and successively outputs the frame numbers of the selected frames to the text-superimposed frame detection unit 2103. Here, the credit-title segment judgment control unit 2101 sets a frame analysis window having a certain width similarly to the setting of the frame analysis window by the processing target frame control unit 2001 shown in FIG. 6. The window width of the frame analysis window set by the credit-title segment judgment control unit 2101 may either be equal to or different from that of the frame analysis window determined by the processing target frame control unit 2001.

The high confident segment including credit title in-video analysis unit 2102 is supplied with the video data inputted from the input unit 11 and the high confident segment including credit title information inputted from the high confident segment including credit title detection unit 201. The high confident segment including credit title in-video analysis unit 2102 analyzes the video data in the high confident segment including credit title. The high confident segment including credit title in-video analysis unit 2102 outputs the result of the analysis, especially the result of analysis employing characteristics common to the characters (letters) in the credit title, to the text-superimposed frame detection unit 2103 as a high confident segment including credit title in-video analysis result. This process is executed for extracting information that contributes to improvement of the detection accuracy of the text-superimposed frame detection unit 2103.

The information obtained by the analysis by the high confident segment including credit title in-video analysis unit 2102 can include a variety of information, such as character moving distance information (exclusively for credit title of the moving type), character font information (in-character color, presence/absence of the edge, edge color, character stroke width, character aspect ratio, character size, layout of characters, etc.) and character display area information, for example.

In the case where the credit title is of the moving type, the high confident segment including credit title in-video analysis unit 2102 calculates an inter-field character moving distance (which can be calculated for each frame) in each frame image in the high confident segment including credit title. Taking advantage of the fact that the characters in the credit title generally have the nature of moving in a constant direction at a constant speed, the mode (most frequent value) of the inter-field character moving distances calculated in the high confident segment including credit title in this process is usable as a numerical value representing the moving speed of the characters in the credit title.

When focusing on the character font (especially the character color), specifically, the high confident segment including credit title in-video analysis unit 2102 first calculates the frame edge images in the high confident segment including credit title and determines an area in which edges appear with high density in consecutive frames as an in-frame high-accuracy character display area. Subsequently, the high confident segment including credit title in-video analysis unit 2102 acquires color information on pixels from which the edges are extracted in the in-frame high-accuracy character display area. Considering the nature of the credit title that characters of the same color are used in many cases, the color information acquired here includes most of the character colors in the credit title. Also when focusing on character font information other than the character color, the high confident segment including credit title in-video analysis unit 2102 can acquire the information by first determining the in-frame high-accuracy character display area similarly to the case focusing on the character color.

When focusing on the character display area (in which characters are displayed), the high confident segment including credit title in-video analysis unit 2102 determines an area in the credit title where characters are displayed with high probability, by use of the nature of the credit title being continuously displayed in a particular area on the screen for a certain length of time and the continuity of the in-frame high-accuracy character display area throughout the high confident segment including credit title. Specifically, the high confident segment including credit title in-video analysis unit 2102 considers an analysis window having a certain width, calculates the in-frame high-accuracy character display area using the frames in the analysis window, and thereafter shifts the analysis window and similarly executes the calculation of the in-frame high-accuracy character display area. This process is executed for the whole of the high confident segment including credit title. An area in which the number of overlapping in-frame high-accuracy character display areas (each calculated at each analysis window position) is the maximum can be regarded as an area in which characters in the credit title are displayed with high probability.

The text-superimposed frame detection unit 2103 executes a telop detection process similar to the telop detection process executed by the text-superimposed frame detection unit 2002 shown in FIG. 6, except for the following difference: The text-superimposed frame detection unit 2103 receives the video analysis result of the high confident segment including credit title from the high confident segment including credit title in-video analysis unit 2102 and executes the telop detection process by use of the video analysis result.

For example, in cases where information on the character moving distance is inputted from the high confident segment including credit title in-video analysis unit 2102 as the video analysis result of the high confident segment including credit title, the text-superimposed frame detection unit 2103 carries out the telop detection process by analyzing changes in the number of edges in the frame image caused by executing motion compensation corresponding to the character moving distance. In cases where information on the character color is inputted, the text-superimposed frame detection unit 2103 also acquires information on the in-frame high-accuracy character display area and carries out the telop detection process by calculating occupancy ratio of the character color in the in-frame high-accuracy character display area. In cases where information on the character display area is inputted, the text-superimposed frame detection unit 2103 carries out the telop detection process after weighting the character display area in the frame image.

The credit-title existence/nonexistence judgment unit 2003 makes a judgment on the existence/nonexistence of the credit title for the analysis window set by the credit-title segment judgment control unit 2101, by checking whether or not text-superimposed frames appear in the analysis window continuously and with a prescribed ratio or higher, whether or not text-superimposed frames exist in the analysis window with a prescribed ratio or higher, etc. Thereafter, the credit-title existence/nonexistence judgment unit 2003 outputs the judgment result to the credit-title segment judgment control unit 2101 as the credit-title existence/nonexistence judgment result. This function is identical with that of the credit-title existence/nonexistence judgment unit 2003 shown in FIG. 6.

Incidentally, the credit-title segment starting/ending point detection unit 202a is capable of executing the credit-title search process either forward or backward in time. In the search forward in time, the credit-title segment starting/ending point detection unit 202a starts the search using the analysis window from a position one frame before the starting point of the high-reliability credit-title segment (whose forefront frame has been determined in the step S2013 in FIG. 8 and which has been inputted to the credit-title segment starting/ending point detection unit 202a). In the search backward in time, the credit-title segment starting/ending point detection unit 202a starts the search using the analysis window from a position one frame after the ending point of the high-reliability credit-title segment (whose end frame has been determined in the step S2016 in FIG. 9 and which has been inputted to the credit-title segment starting/ending point detection unit 202a). When a judgment result indicating that a credit title exists in the analysis windows is returned from the credit-title existence/nonexistence judgment unit 2003 as the result of the credit-title existence/nonexistence judgment on the frames in the analysis windows, the credit-title segment starting/ending point detection unit 202a successively shifts the analysis window and further executes the credit-title existence/nonexistence judgment process at each analysis window position. At the point when a judgment result indicating that no credit-title exists is returned, the credit-title segment starting/ending point detection unit 202a regards a segment formed by connecting the analysis windows that have been judged to display the credit title as the credit-title segment and outputs information representing the credit-title segment to the output unit 14.

Meanwhile, the credit-title segment starting/ending point detection unit 202b shown in FIG. 11 includes a high confident segment including credit title front/rear adjacent segment parameter redetermination unit 2104, a text-superimposed frame detection unit 2105 and a credit-title existence/nonexistence judgment unit 2003.

The high confident segment including credit title front/rear adjacent segment parameter redetermination unit 2104 has functions including the function of the credit-title segment judgment control unit 2101 shown in FIG. 10. The high confident segment including credit title front/rear adjacent segment parameter redetermination unit 2104 receives the high confident segment including credit title information from the high confident segment including credit title detection unit 201 and redetermines the processing target frames and parameter values in regard to segments adjacent to the front and rear ends of the high confident segment including credit title. Specifically, the high confident segment including credit title front/rear adjacent segment parameter redetermination unit 2104 changes parameter values for the edge detection, etc. in a direction facilitating the text-superimposed frame detection compared to the process executed in the high confident segment including credit title detection unit 201. Thereafter, the high confident segment including credit title front/rear adjacent segment parameter redetermination unit 2104 outputs the changed parameter values to the text-superimposed frame detection unit 2105 together with the frame number information on the processing target frames.

The text-superimposed frame detection unit 2105 executes a telop detection process similar to that executed by the text-superimposed frame detection unit 2002 shown in FIG. 6 except that the text-superimposed frame detection unit 2105 executes the telop detection process using the parameter values redetermined by the high confident segment including credit title front/rear adjacent segment parameter redetermination unit 2104. Thus, detailed explanation of the process is omitted for brevity. The credit-title existence/nonexistence judgment unit 2003 executes a judgment process similar to the credit-title existence/nonexistence judgment process executed by the credit-title existence/nonexistence judgment unit 2003 shown in FIG. 10.

In the credit-title detection in the first exemplary embodiment, starting of the detection process not from the forefront frame of the video data but from a region having a high probability of existence of the credit title is realized by use of a large number of programs, by which speeding up of the credit-title detection process is made possible. The two-stage process, first detecting the segment in which the credit title seems to be displayed with high reliability and thereafter extending the range of the search and detection the starting point and the ending point of the credit-title segment, realizes improvement of the accuracy of the credit-title segment detecting process.

### Second Exemplary Embodiment

A second exemplary embodiment (exemplary embodiment 2) of the credit-title segment detection device in accordance with the present invention will be described below with reference to figures.

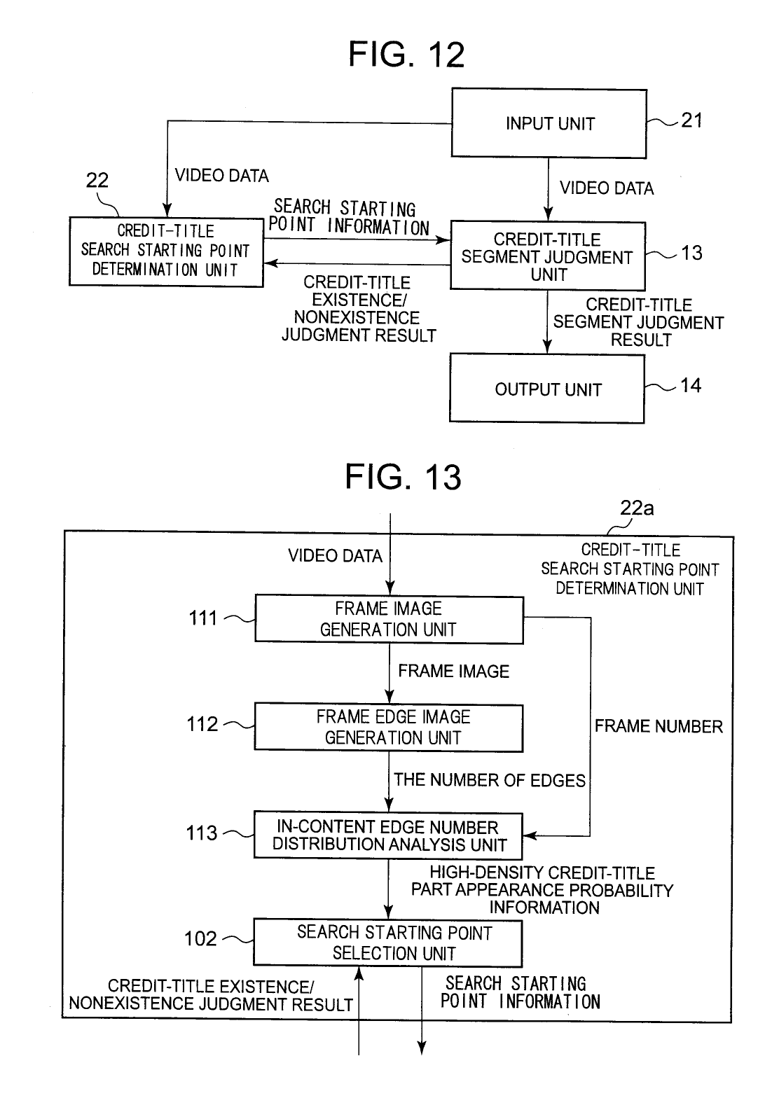

FIG. 12 is a block diagram showing the general configuration of the second exemplary embodiment of the credit-title segment detection device in accordance with the present invention. The general configuration of the second exemplary embodiment differs from that of the first exemplary embodiment in that the video data is inputted from an input unit 21 to a credit-title search starting point determination unit 22. The other components are equivalent to those in the general configuration of the first exemplary embodiment shown in FIG. 1 and thus detailed explanation thereof is omitted. The credit-title search starting point determination unit 22 determines the search starting point not by using the video learning result but by directly receiving the video data from the input unit 21 and using the video data. Further details of the credit-title search starting point determination unit 22 will be explained below.

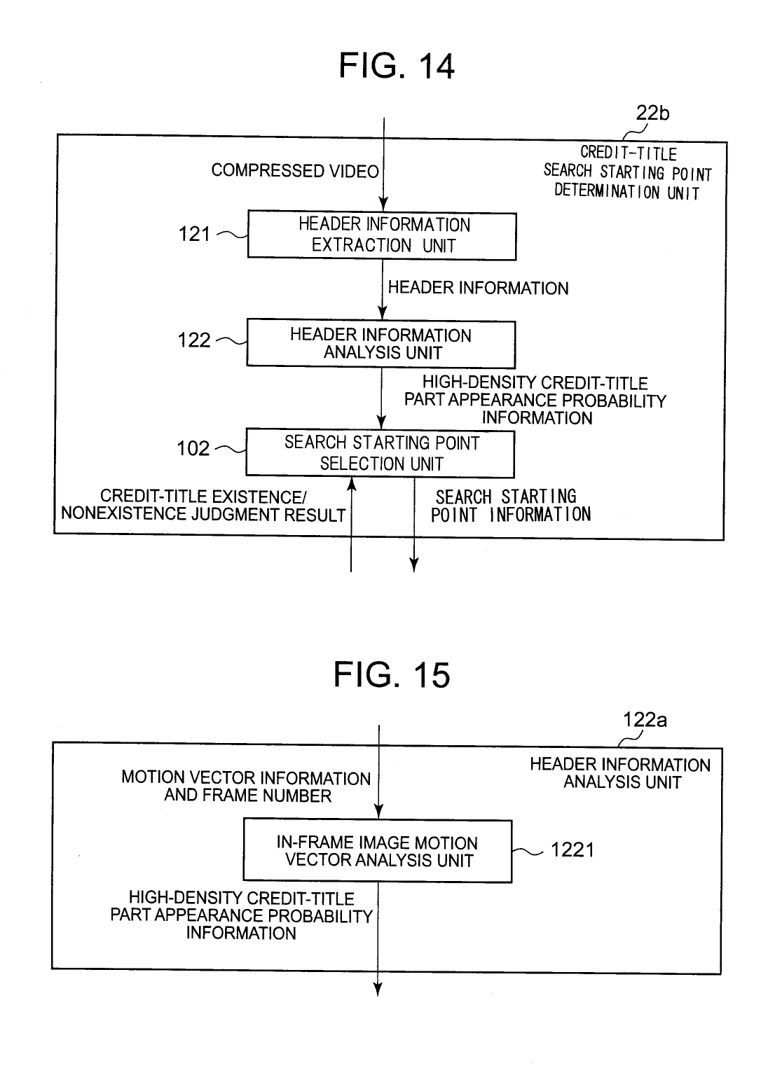

FIGS. 13 and 14 are block diagrams showing examples of the configuration of the credit-title search starting point determination unit shown in FIG. 12. Credit-title search starting point determination units 22a and 22b as the configuration examples of the credit-title search starting point determination unit 22 will be explained below referring to FIGS. 13 and 14.

The credit-title search starting point determination unit 22a shown in FIG. 13 includes a frame image generation unit 111, a frame edge image generation unit 112, an in-content edge number distribution analysis unit 113 and a search starting point selection unit 102. The search starting point selection unit 102 is equivalent to that in the first exemplary embodiment, and thus detailed explanation thereof is omitted.

The frame image generation unit 111 receives the video data from the input unit 21 and generates each frame image from the video data. When the video data is compressed video, the frame image generation unit 111 constructs the frame image by decoding the compressed video. When the video data is uncompressed video which has already been decoded, the frame image generation unit 111 constructs the frame image by extraction. In this case, it is desirable that not every frame but frames selected at prescribed segments be handled as the processing target frames.

The frame edge image generation unit 112 receives the frame image from the frame image generation unit 111 and generates the frame edge image by using an edge detection filter (two-dimensional Laplacian filter, Canny filter, etc.) for the frame image.

The in-content edge number distribution analysis unit 113, receiving the number of edges in the frame edge image from the frame edge image generation unit 112 and the frame number of the frame image as the processing target from the frame image generation unit 111 and thereby calculates the high-density credit-title part appearance probability information. This probability takes on high values in a region (made of frames at preset frame segments) in which the number of edges is large since such a region is judged to have high character density in the credit title. Conversely, the probability takes on low values in a region in which the number of edges is small.

Meanwhile, the credit-title search starting point determination unit 22b shown in FIG. 14 includes a header information extraction unit 121, a header information analysis unit 122 and a search starting point selection unit 102. The search starting point selection unit 102 is equivalent to that in the first exemplary embodiment, and thus detailed explanation thereof is omitted.

The header information extraction unit 121 extracts header information contained in the compressed video inputted from the input unit 21. When video compressed in the MPEG format is inputted, for example, information on a motion vector, which is determined for each macro block, is contained in the header information. This information is acquired by the header information extraction unit 121. The header information also contains information on the mode of DCT (frame DCT or field DCT) used in units of macro blocks. This information may also be acquired by the header information extraction unit 121.

The header information analysis unit 122 receives the header information from the header information extraction unit 121 and calculates the high-density credit-title part appearance probability information. Further details of the header information analysis unit 122 will be explained below.

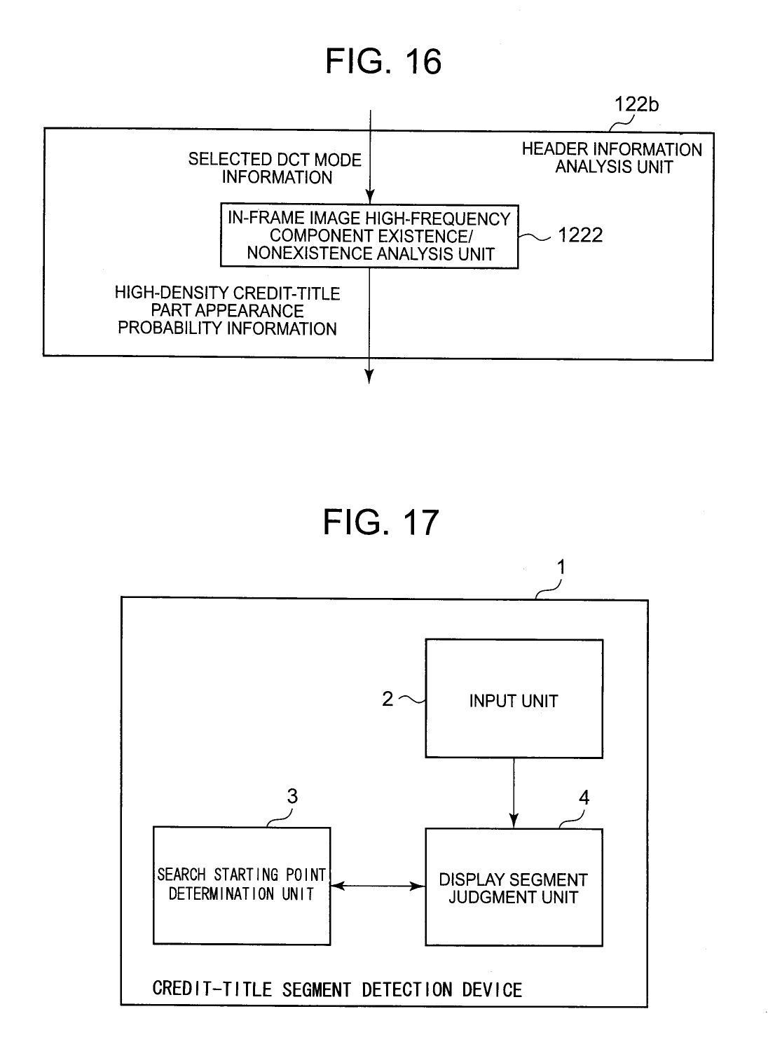

FIGS. 15 and 16 are block diagrams showing examples of the configuration of the header information analysis unit. Header information analysis units 122a and 122b as the configuration examples of the header information analysis unit 122 will be explained below referring to FIGS. 15 and 16.

The header information analysis unit 122a shown in FIG. 15 can be implemented by an in-frame image motion vector analysis unit 1221. However, this configuration is possible only when the credit title is of the moving type. In such a configuration, the in-frame image motion vector analysis unit 1221 extracts the motion vector information and the frame numbers from the header information extraction unit 121 and calculates the high-density credit-title part appearance probability information by use of the extracted information. This probability takes on high values in a region in which the degree of uniformity of directions of motion vectors in the frame image is high and the motion vector directions do not change much in the fixed frame segment, since such a region is judged to include a high character density region in the credit title. Conversely, the probability takes on low values in a region in which the degree of uniformity of the motion vector directions in the frame image is low. These tendencies are caused by the nature of the credit title that the moving direction and the moving speed are constant in credit title of the moving type.

Meanwhile, the header information analysis unit 122b shown in FIG. 16 can be implemented by an in-frame image high-frequency component existence/nonexistence analysis unit 1222. However, this configuration is also only possible when the credit title is of the moving type. In such a configuration, the in-frame image high-frequency component existence/nonexistence analysis unit 1222 extracts information on the selected DCT mode and the frame number from the header information extraction unit 121 and calculates the high-density credit-title part appearance probability information by use of the extracted information. This probability takes on high values in a region in which the field DCT is selected many times in the frame image and the inclination continues in the fixed frame segment, since such a region is judged to have high character density in the credit title. Conversely, the probability takes on low values in a region in which the frame DCT is selected many times. These tendencies are caused as below. In a segment on which the credit title is superimposed, each frame image includes a large number of areas in which pixels aligned in the vertical direction take on high values and low values alternately. In such a segment, the field DCT tends to be selected due to the increase in high-frequency components.

In the credit-title detection in the second exemplary embodiment, a region having a high probability of existence of credit title is roughly detected first, and thereafter the detection process is started from the region. Thus, without the need of executing the detection process from the forefront frame of the video data, speeding up of the credit-title detection process is made possible. The two-stage process, first detecting the segment in which the credit title seems to be displayed with high reliability and thereafter extending the range of the search from there and detecting the starting point and the ending point of the credit-title segment, realizes improvement of the accuracy of the credit-title segment detecting process.

FIG. 17 is a block diagram showing the principal part of the credit-title segment detection device in accordance with the present invention. As shown in FIG. 17, the credit-title segment detection device 1 comprises: an input unit 2 (e.g., the input unit 11 shown in FIG. 1) for inputting video data of video content; a search starting point determination unit 3 (e.g., the credit-title search starting point determination unit 12 shown in FIG. 1) for determining a starting point which represents a temporal position for starting a credit-title search process based on an existence probability of a high character density part of the credit title in which characters are displayed with high density in the credit-title segment; and a display segment judgment unit 4 (e.g., the credit-title segment judgment unit 13 shown in FIG. 1) for judging the display segment of the credit title by first executing the credit-title search process to the starting point and thereafter successively extending a segment as the target of the search process forward and backward from the starting point. In the credit-title segment detection device configured as above, the display segment of the credit title is judged by starting the search from the high character density part (where character string density in a credit title is high and the probability of detecting the credit title is high), and the search for the credit title in the display segment is carried out. Therefore, the detection of the credit title can be speeded up and the accuracy of the credit-title detection process can be increased.

The above exemplary embodiments have also disclosed credit-title segment detection devices configured as the following (1)-(16):

(1) When no credit titles are judged to exist in the credit-title search process executed to the starting point, the display segment judgment unit requests the search starting point determination unit to redetermine the starting point of the search process until a temporal position where the credit title exists is found and thereafter makes a judgment on the display segment of the credit title by starting the search process from the redetermined starting point as the position where the credit title has been judged to exist (implemented by the steps S102-S104, for example). In the credit-title segment detection device configured as above, the speed of the credit-title detection can be increased.

(2) The credit-title segment detection device may further comprise a learning result storage unit (e.g., the video learning result storage unit 101 shown in FIG. 3) for determining the existence probability of the high character density part of the credit title by learning multiple items of video content and storing the determined probability information as high-density credit-title part appearance probability information. The search starting point determination unit (implemented by the credit-title search starting point determination unit 12a in the first exemplary embodiment, for example) determines the starting point for starting the credit-title search process based on the high-density credit-title part appearance probability information stored in the learning result storage unit. In the credit-title segment detection device configured as above, the credit-title search starting point is searched for and determined based on information on characteristics of credit title which has previously been learned and accumulated. Therefore, the speed of the credit-title detection can be increased.

(3) The learning result storage unit (e.g., the video learning result storage unit 101b shown in FIG. 4) stores in-content credit-title appearance probability information which is calculated by learning segments displaying credit title in multiple items of video content and in-credit-title high character density part appearance probability information which is calculated by learning character density in such segments displaying credit title. The learning result storage unit includes an appearance probability information calculation unit for calculating the high-density credit-title part appearance probability information based on the in-content credit-title appearance probability information and the in-credit-title high character density part appearance probability information. The search starting point determination unit (implemented by the credit-title search starting point determination unit 12b in the first exemplary embodiment, for example) determines the starting point for starting the credit-title search process based on the high-density credit-title part appearance probability information calculated by the appearance probability information calculation unit. In the credit-title segment detection device configured as above, the credit-title search starting point is searched for and determined based on information on characteristics of a credit title which has previously been learned and accumulated. Therefore, the speed of the credit-title detection can be increased.

(4) The learning result storage unit stores distribution assumed to have high values around its central part as the in-credit-title high character density part appearance probability information (described in an example of the processing by the high-density credit-title part appearance probability information calculation unit 103 in the first exemplary embodiment, for example). In the credit-title segment detection device configured as above, the speed of the process for calculating the high-density credit-title part appearance probability information (calculated by reading out the in-credit-title high character density part appearance probability information) can be increased.

(5) The search starting point determination unit (implemented by the credit-title search starting point determination unit 22 in the second exemplary embodiment, for example) determines the starting point for starting the credit-title search process by estimating the existence probability of the high character density part of the credit title by use of a feature quantity acquired by analyzing the inputted video data of the video content. In the credit-title segment detection device configured as above, a region having a high probability of existence of a credit title is roughly detected first and thereafter the detection process is started from the region, for example, by which the need of executing the detection process from the forefront frame of the video data is eliminated and speeding up of the credit-title detection process is realized.

(6) The feature quantity is distribution of the number of edges. The search starting point determination unit generates a frame image from the inputted video data (e.g., the frame image generation unit 111), generates a frame edge image by calculating edge components of the generated frame image (e.g., the frame edge image generation unit 112), calculates high-density credit-title part appearance probability information by analyzing distribution of the number of edges of the frame edge image in the content (e.g., the in-content edge number distribution analysis unit 113), and determines the starting point for starting the credit-title search process based on the calculated high-density credit-title part appearance probability information (implemented by the credit-title search starting point determination unit 22a in the second exemplary embodiment, for example). In the credit-title segment detection device configured as above, the accuracy of the process for determining the starting point of the credit-title search process can be increased by employing the analysis of the number of edges, by which the probability of existence of the credit title at the determined starting point can be increased.

(7) The feature quantity is a statistic acquired from header information and the video data is compressed data. The search starting point determination unit extracts the header information contained in the inputted compressed video data (e.g., the header information extraction unit 121), calculates high-density credit-title part appearance probability information by analyzing the extracted header information (e.g., the header information analysis unit 122), and determines the starting point for starting the credit-title search process based on the calculated high-density credit-title part appearance probability information (implemented by the credit-title search starting point determination unit 22b in the second exemplary embodiment, for example). In the credit-title segment detection device configured as above, the accuracy of the process for determining the starting point of the credit-title search process can be increased by using the header information, by which the probability of existence of the credit title at the determined starting point can be increased.

(8) The statistic is a motion vector which is determined for each macro block. The search starting point determination unit calculates the high-density credit-title part appearance probability information by analyzing the degree of uniformity of directions of the motion vectors in the frame image (e.g., the in-frame image motion vector analysis unit 1221). In the credit-title segment detection device configured as above, the accuracy of the process for determining the starting point of the credit-title search process can be increased by analyzing the degree of uniformity of directions of the motion vectors in the frame image, by which the probability of existence of the credit title at the determined starting point can be increased.

(9) The statistic is a DCT mode which is determined for each macro block. The search starting point determination unit calculates the high-density credit-title part appearance probability information by analyzing the existence/nonexistence of high-frequency components by using the frequency or distribution of selection of field DCT in the frame image (e.g., the in-frame image high-frequency component existence/nonexistence analysis unit 1222). In the credit-title segment detection device configured as above, the accuracy of the process for determining the starting point of the credit-title search process can be increased by analyzing the existence/nonexistence of high-frequency components in the frame image, by which the probability of existence of the credit title at the determined starting point can be increased.

(10) The display segment judgment unit detects a starting point and an ending point of the credit-title segment by first detecting a segment in which the credit title can be detected with high reliability as a high confident segment including credit title and then successively extending the segment as the target of the credit-title search process forward and backward from the high confident segment including credit title (implemented by the credit-title segment starting/ending point detection unit 202, for example). In the credit-title segment detection device configured as above, the accuracy of the credit-title segment detecting process can be increased by the two-stage process first detecting the segment in which the credit title seems to be displayed with high reliability and thereafter extending the range of the search and detection the starting point and the ending point of the credit-title segment.

(11) The display segment judgment unit calculates the high confident segment including credit title information by first executing a text-superimposed frame detection process to a candidate point for the starting point of the credit-title segment for the video data inputted from the input unit and then judging continuity of the text-superimposed frames taking advantage of the nature of the credit-title segment being in many cases longer than other telop display segments (implemented by the steps 2001-S2010, for example). In the credit-title segment detection device configured as above, the efficiency of the credit-title segment detecting process can be increased since the information on the segment in which the credit title exists with high reliability is calculated based on the continuity of the text-superimposed frames.

(12) The display segment judgment unit judges the credit-title segment (e.g., the credit-title existence/nonexistence judgment unit 2003 included in the credit-title segment starting/ending point detection unit 202b) by redetermining parameter values used in the text-superimposed frame detection process in regard to segments adjacent to front and rear ends of the high confident segment including credit title so as to facilitate the text-superimposed frame detection (e.g., the high confident segment including credit title front/rear adjacent segment parameter redetermination unit 2104) and executing the text-superimposed frame detection process using the redetermined parameter values (e.g., the text-superimposed frame detection unit 2105). In the credit-title segment detection device configured as above, the efficiency of the text-superimposed frame detection process can be increased.

(13) The display segment judgment unit judges the credit-title segment by analyzing segments adjacent to front and rear ends of the high confident segment including credit title by use of a telop-related feature quantity which is acquired by executing video analysis to a segment specified by the high confident segment including credit title information for the video data inputted from the input unit (e.g., the high confident segment including credit title in-video analysis unit 2102). In the credit-title segment detection device configured as above, the accuracy of the detection of the text-superimposed frames can be increased by use of the telop-related feature quantity.

(14) The telop-related feature quantity is character moving distance of the telop. The display segment judgment unit judges the credit-title segment by analyzing changes in the number of edges in the frame image caused by executing motion compensation corresponding to the character moving distance in segments adjacent to front and rear ends of the high confident segment including credit title (implemented by the operation of the high confident segment including credit title in-video analysis unit 2102 in the case where the credit title is of the moving type, for example). In the credit-title segment detection device configured as above, the accuracy of the detection of the text-superimposed frames can be increased by use of the telop-related feature quantity.

(15) The telop-related feature quantity is character color in an area in the frame image having a high probability of displaying character strings. The display segment judgment unit judges the credit-title segment by analyzing occupancy ratio of the character color in the area in the frame image in segments adjacent to front and rear ends of the high confident segment including credit title (implemented by the operation of the high confident segment including credit title in-video analysis unit 2102 when focusing on the character color, for example). In the credit-title segment detection device configured as above, the accuracy of the detection of the text-superimposed frames can be increased by use of the telop-related feature quantity.

(16) The telop-related feature quantity is display area information on the telop. The display segment judgment unit judges the credit-title segment by executing a telop detection process after weighting an area in the frame image specified by the display area information in segments adjacent to front and rear ends of the high confident segment including credit title (implemented by the operation of the high confident segment including credit title in-video analysis unit 2102 when focusing on the character display area, for example). In the credit-title segment detection device configured as above, the accuracy of the detection of the text-superimposed frames can be increased by use of the telop-related feature quantity.

While the present invention has been described above with reference to the exemplary embodiments and examples, the present invention is not to be restricted to the particular illustrative exemplary embodiments and examples. A variety of modifications understandable to those skilled in the art can be made to the configuration and details of the present invention within the scope of the present invention.

This application claims priority to Japanese Patent Application No. 2009-1172 filed on Jan. 6, 2009, the entire disclosure of which is incorporated herein by reference.

### INDUSTRIAL APPLICABILITY

The present invention, which realizes the detection of the segment of the credit titles (e.g., telop for displaying the copyright holder, cast, etc.) used in broadcast programs and the like, is applicable to systems for extracting information on rights for secondary use of broadcast programs.

### REFERENCE SIGNS LIST

1 credit-title segment detection device
2 input unit
3 search starting point determination unit
4 display segment judgment unit
11 input unit
12, 12a, 12b, 22, 22a, 22b credit-title search starting point determination unit
13 credit-title segment judgment unit
14 output unit
101, 101a, 101b video learning result storage unit
102 search starting point selection unit
103 high-density credit-title part appearance probability information calculation unit
111 frame image generation unit
112 frame edge image generation unit
113 in-content edge number distribution analysis unit
121 header information extraction unit
122, 122a, 122b header information analysis unit
201 high confident segment including credit title detection unit
202, 202a, 202b credit-title segment starting/ending point detection unit
1221 in-frame image motion vector analysis unit
1222 in-frame image high-frequency component existence/nonexistence analysis unit
2001 processing target frame control unit
2002 text-superimposed frame detection unit
2003 credit-title existence/nonexistence judgment unit
2101 credit-title segment judgment control unit
2102 high confident segment including credit title in-video analysis unit
2103 text-superimposed frame detection unit
2104 high confident segment including credit title front/rear adjacent segment parameter redetermination unit
2105 text-superimposed frame detection unit

1-51. (canceled)

52. A credit-title segment detection device for detecting a display segment of a credit title from video content, comprising:
an input unit for inputting video data of the video content;
a search starting point determination unit for determining a starting point which represents a temporal position for starting a credit-title search process based on an existence probability of a high character density part of the credit title in the credit-title segment; and
a display segment judgment unit for judging the display segment of the credit title by first executing the credit-title search process to the starting point and thereafter successively extending a segment as the target of the search process forward and backward from the starting point.

53. The credit-title segment detection device according to claim 52, wherein when no credit titles are judged to exist in the credit-title search process executed to the starting point, the display segment judgment unit requests the search starting point determination unit to redetermine the starting point of the search process until a temporal position where the credit title exists is found and thereafter makes a judgment on the display segment of the credit title by starting the search process from the redetermined starting point as the position where the credit title has been judged to exist.

54. The credit-title segment detection device according to claim 52, further comprising a learning result storage unit for determining the existence probability of the high character density part of the credit title by learning multiple items of video content and storing the determined probability information as high-density credit-title part appearance probability information,
wherein the search starting point determination unit determines the starting point for starting the credit-title search process based on the high-density credit-title part appearance probability information stored in the learning result storage unit.

55. The credit-title segment detection device according to claim 52,
wherein: the learning result storage unit stores in-content credit-title appearance probability information which is calculated by learning segments displaying a credit title in multiple items of video content and in-credit-title high character density part appearance probability information which is calculated by learning character density in such segments displaying a credit title, and
the credit-title segment detection device further comprising an appearance probability information calculation unit for calculating the high-density credit-title part appearance probability information based on the in-content credit-title appearance probability information and the in-credit-title high character density part appearance probability information, and
the search starting point determination unit determines the starting point for starting the credit-title search process based on the high-density credit-title part appearance probability information calculated by the appearance probability information calculation unit.

56. The credit-title segment detection device according to claim 55, wherein the learning result storage unit stores distribution assumed to have high values around its central part as the in-credit-title high character density part appearance probability information.

57. The credit-title segment detection device according to claim 52, wherein the search starting point determination unit determines the starting point for starting the credit-title search process by estimating the existence probability of the high character density part of the credit title by use of a feature quantity acquired by analyzing the inputted video data of the video content.

58. The credit-title segment detection device according to claim 57,
wherein: the feature quantity is distribution of the number of edges, and
the search starting point determination unit generates a frame image from the inputted video data, generates a frame edge image by calculating edge components of the generated frame image, calculates high-density credit-title part appearance probability information by analyzing distribution of the number of edges of the frame edge image in the content, and determines the starting point for starting the credit-title search process based on the calculated high-density credit-title part appearance probability information.

59. The credit-title segment detection device according to claim 57,
wherein: the feature quantity is a statistic acquired from header information and the video data is compressed data, and
the search starting point determination unit extracts the header information contained in the inputted compressed video data, calculates high-density credit-title part appearance probability information by analyzing the extracted header information, and determines the starting point for starting the credit-title search process based on the calculated high-density credit-title part appearance probability information.

60. The credit-title segment detection device according to claim 59,
wherein: the statistic is a motion vector which is determined for each macro block, and
the search starting point determination unit calculates the high-density credit-title part appearance probability information by analyzing the degree of uniformity of directions of the motion vectors in the frame image.

61. The credit-title segment detection device according to claim 59,
wherein: the statistic is a DCT mode which is determined for each macro block, and
the search starting point determination unit calculates the high-density credit-title part appearance probability information by analyzing the existence/nonexistence of high-frequency components by using the frequency or distribution of selection of field DCT in the frame image.

62. The credit-title segment detection device according to claim 52, wherein the display segment judgment unit detects a starting point and an ending point of the credit-title segment by first detecting a segment in which the credit title can be detected with high reliability as a high confident segment including credit title and then successively extending the segment as the target of the credit-title search process forward and backward from the high confident segment including credit title.

63. The credit-title segment detection device according to claim 62, wherein the display segment judgment unit calculates the high confident segment including credit title information by first executing a text-superimposed frame detection process to a candidate point for the starting point of the credit-title segment for the video data inputted from the input unit and then judging continuity of the text-superimposed frames taking advantage of the nature of the credit-title segment being in many cases longer than other telop display segments.

64. The credit-title segment detection device according to claim 63, wherein the display segment judgment unit judges the credit-title segment by redetermining parameter values used in the text-superimposed frame detection process in regard to segments adjacent to front and rear ends of the high confident segment including credit title so as to facilitate the text-superimposed frame detection and executing the text-superimposed frame detection process using the redetermined parameter values.

65. The credit-title segment detection device according to claim 63, wherein the display segment judgment unit judges the credit-title segment by analyzing segments adjacent to front and rear ends of the high confident segment including credit title by use of a telop-related feature quantity which is acquired by executing video analysis to a segment specified by the high confident segment including credit title information for the video data inputted from the input unit.

66. The credit-title segment detection device according to claim 65,
wherein: the telop-related feature quantity is character moving distance of the telop, and
the display segment judgment unit judges the credit-title segment by analyzing changes in the number of edges in the frame image caused by executing motion compensation corresponding to the character moving distance in segments adjacent to front and rear ends of the high confident segment including credit title.

67. The credit-title segment detection device according to claim 65,
wherein: the telop-related feature quantity is character color in an area in the frame image having a high probability of displaying character strings, and
the display segment judgment unit judges the credit-title segment by analyzing occupancy ratio of the character color in the area in the frame image in segments adjacent to front and rear ends of the high confident segment including credit title.

68. The credit-title segment detection device according to claim 65,
wherein: the telop-related feature quantity is display area information on the telop, and
the display segment judgment unit judges the credit-title segment by executing a telop detection process after weighting an area in the frame image specified by the display area information in segments adjacent to front and rear ends of the high confident segment including credit title.

69. A credit-title segment detection method for detecting a display segment of a credit title from video content, comprising the steps of:
inputting video data of the video content;
determining a starting point which represents a temporal position for starting a credit-title search process based on an existence probability of a high character density part of the credit title in the credit-title segment; and
judging the display segment of the credit title by first executing the credit-title search process to the starting point and thereafter successively extending a segment as the target of the search process forward and backward from the starting point.

70. The credit-title segment detection method according to claim 69, wherein when no credit titles are judged to exist in the credit-title search process executed to the starting point, the starting point of the search process is redetermined until a temporal position where the credit title exists is found and thereafter the judgment on the display segment of the credit title is made by starting the search process from the redetermined starting point as the position where the credit title has been judged to exist.

71. The credit-title segment detection method according to claim 69, comprising the steps of:
determining the existence probability of the high character density part of the credit title by learning multiple items of video content;
storing the determined probability information as high-density credit-title part appearance probability information; and
determining the starting point for starting the credit-title search process based on the high-density credit-title part appearance probability information.

72. The credit-title segment detection method according to claim 69, comprising the steps of:
storing in-content credit-title appearance probability information which is calculated by learning segments displaying a credit title in multiple items of video content and in-credit-title high character density part appearance probability information which is calculated by learning character density in such segments displaying a credit title;
calculating high-density credit-title part appearance probability information based on the in-content credit-title appearance probability information and the in-credit-title high character density part appearance probability information; and
determining the starting point for starting the credit-title search process based on the high-density credit-title part appearance probability information.

73. The credit-title segment detection method according to claim 72, wherein distribution assumed to have high values around its central part is stored as the in-credit-title high character density part appearance probability information.

74. The credit-title segment detection method according to claim 69, wherein the starting point for starting the credit-title search process is determined by estimating the existence probability of the high character density part of the credit title by use of a feature quantity acquired by analyzing the inputted video data of the video content.

75. The credit-title segment detection method according to claim 74,
wherein: the feature quantity is distribution of the number of edges, and
the credit-title segment detection method comprises the steps of:
generating a frame image from the inputted video data;
generating a frame edge image by calculating edge components of the frame image;
calculating high-density credit-title part appearance probability information by analyzing distribution of the number of edges of the frame edge image in the content; and
determining the starting point for starting the credit-title search process based on the high-density credit-title part appearance probability information.

76. The credit-title segment detection method according to claim 74,
wherein: the feature quantity is a statistic acquired from header information and the video data is compressed data, and
the credit-title segment detection method comprises the steps of:
extracting the header information contained in the inputted compressed video data;
calculating high-density credit-title part appearance probability information by analyzing the extracted header information; and
determining the starting point for starting the credit-title search process based on the high-density credit-title part appearance probability information.

77. The credit-title segment detection method according to claim 76,
wherein: the statistic is a motion vector which is determined for each macro block, and
the high-density credit-title part appearance probability information is calculated by analyzing the degree of uniformity of directions of the motion vectors in the frame image.

78. The credit-title segment detection method according to claim 76,
wherein: the statistic is a DCT mode which is determined for each macro block, and
the high-density credit-title part appearance probability information is calculated by analyzing the existence/nonexistence of high-frequency components by using the frequency or distribution of selection of field DCT in the frame image.

79. The credit-title segment detection method according to claim 69, comprising the steps of:
detecting a segment in which the credit title can be detected with high reliability as a high confident segment including credit title; and
detecting a starting point and an ending point of the credit-title segment by successively extending the segment as the target of the credit-title search process forward and backward from the high confident segment including credit title.

80. The credit-title segment detection method according to claim 79, wherein the high confident segment including credit title information is calculated by first executing a text-superimposed frame detection process to a candidate point for the starting point of the credit-title segment for the inputted video data and then judging continuity of the text-superimposed frames taking advantage of the nature of the credit-title segment being in many cases longer than other telop display segments.

81. The credit-title segment detection method according to claim 80, wherein the credit-title segment is judged by redetermining parameter values used in the text-superimposed frame detection process in regard to segments adjacent to front and rear ends of the high confident segment including credit title so as to facilitate the text-superimposed frame detection and executing the text-superimposed frame detection process using the redetermined parameter values.

82. The credit-title segment detection method according to claim 80, wherein the credit-title segment is judged by analyzing segments adjacent to front and rear ends of the high confident segment including credit title by use of a telop-related feature quantity which is acquired by executing video analysis to a segment specified by the high confident segment including credit title information for the inputted video data.

83. The credit-title segment detection method according to claim 82,
wherein: the telop-related feature quantity is character moving distance of the telop, and
the credit-title segment is judged by analyzing changes in the number of edges in the frame image caused by executing motion compensation corresponding to the character moving distance in segments adjacent to front and rear ends of the high confident segment including credit title.

84. The credit-title segment detection method according to claim 82,
wherein: the telop-related feature quantity is character color in an area in the frame image having a high probability of displaying character strings, and
the credit-title segment is judged by analyzing occupancy ratio of the character color in the area in the frame image in segments adjacent to front and rear ends of the high confident segment including credit title.

85. The credit-title segment detection method according to claim 82,
wherein: the telop-related feature quantity is display area information on the telop, and
the credit-title segment is judged by executing a telop detection process after weighting an area in the frame image specified by the display area information in segments adjacent to front and rear ends of the high confident segment including credit title.

86. A credit-title segment detection program which causes a computer for a credit-title segment detection device, for detecting a display segment of a credit title from video content, to execute a process comprising the steps of:
inputting video data of the video content;
determining a starting point which represents a temporal position for starting a credit-title search process based on an existence probability of a high character density part of the credit title in which characters are displayed with high density in the credit-title segment; and
judging the display segment of the credit title by first executing the credit-title search process to the starting point and thereafter successively extending a segment as the target of the search process forward and backward from the starting point.

87. The credit-title segment detection program according to claim 86, wherein when no credit titles are judged to exist in the credit-title search process executed to the starting point, the starting point of the search process is redetermined until a temporal position where the credit title exists is found and thereafter the judgment on the display segment of the credit title is made by starting the search process from the redetermined starting point as the position where the credit title has been judged to exist.

88. The credit-title segment detection program according to claim 86, wherein the process comprises the steps of:
determining the existence probability of the high character density part of the credit title by learning multiple items of video content;
storing the determined probability information as high-density credit-title part appearance probability information; and
determining the starting point for starting the credit-title search process based on the high-density credit-title part appearance probability information.

89. The credit-title segment detection program according to claim 86, wherein the process comprises the steps of:
storing in-content credit-title appearance probability information which is calculated by learning segments displaying a credit title in multiple items of video content and in-credit-title high character density part appearance probability information which is calculated by learning character density in such segments displaying a credit title;
calculating high-density credit-title part appearance probability information based on the in-content credit-title appearance probability information and the in-credit-title high character density part appearance probability information; and
determining the starting point for starting the credit-title search process based on the high-density credit-title part appearance probability information.

90. The credit-title segment detection program according to claim 89, wherein the process comprises a step of storing distribution assumed to have high values around its central part as the in-credit-title high character density part appearance probability information.

91. The credit-title segment detection program according to claim 86, wherein the starting point for starting the credit-title search process is determined by estimating the existence probability of the high character density part of the credit title by use of a feature quantity acquired by analyzing the inputted video data of the video content.

92. The credit-title segment detection program according to claim 91,
wherein: the feature quantity is distribution of the number of edges, and
the process comprises the steps of:
generating a frame image from the inputted video data;
generating a frame edge image by calculating edge components of the frame image;
calculating high-density credit-title part appearance probability information by analyzing distribution of the number of edges of the frame edge image in the content; and
determining the starting point for starting the credit-title search process based on the high-density credit-title part appearance probability information.

93. The credit-title segment detection program according to claim 91,
wherein: the feature quantity is a statistic acquired from header information, and
when the video content has been compressed, the process comprises the steps of:
extracting the header information contained in the inputted compressed video data;
calculating high-density credit-title part appearance probability information by analyzing the extracted header information; and
determining the starting point for starting the credit-title search process based on the high-density credit-title part appearance probability information.

94. The credit-title segment detection program according to claim 93,
wherein: the statistic is a motion vector which is determined for each macro block, and
the high-density credit-title part appearance probability information is calculated by analyzing the degree of uniformity of directions of the motion vectors in the frame image.

95. The credit-title segment detection program according to claim 93,
wherein: the statistic is a DCT mode which is determined for each macro block, and
the high-density credit-title part appearance probability information is calculated by analyzing the existence/nonexistence of high-frequency components by using the frequency or distribution of selection of field DCT in the frame image.

96. The credit-title segment detection program according to claim 86, wherein the process comprises the steps of:
detecting a segment in which the credit title can be detected with high reliability as a high confident segment including credit title; and
detecting a starting point and an ending point of the credit-title segment by successively extending the segment as the target of the credit-title search process forward and backward from the high confident segment including credit title.

97. The credit-title segment detection program according to claim 96, wherein the process comprises the steps of:
executing a text-superimposed frame detection process to a candidate point for the starting point of the credit-title segment for the inputted video data; and
calculating the high confident segment including credit title information by judging continuity of the text-superimposed frames taking advantage of the nature of the credit-title segment being in many cases longer than other telop display segments.

98. The credit-title segment detection program according to claim 97, wherein the process comprises the steps of:
redetermining parameter values used in the text-superimposed frame detection process in regard to segments adjacent to front and rear ends of the high confident segment including credit title so as to facilitate the text-superimposed frame detection; and
judging the credit-title segment by executing the text-superimposed frame detection process using the redetermined parameter values.

99. The credit-title segment detection program according to claim 97, wherein the credit-title segment is judged by analyzing segments adjacent to front and rear ends of the high confident segment including credit title by use of a telop-related feature quantity which is acquired by executing video analysis to a segment specified by the high confident segment including credit title information for the inputted video data.

100. The credit-title segment detection program according to claim 99,
wherein: the telop-related feature quantity is character moving distance of the telop, and
the credit-title segment is judged by analyzing changes in the number of edges in the frame image caused by executing motion compensation corresponding to the character moving distance in segments adjacent to front and rear ends of the high confident segment including credit title.

101. The credit-title segment detection program according to claim 99,
wherein: the telop-related feature quantity is character color in an area in the frame image having a high probability of displaying character strings, and
the credit-title segment is judged by analyzing occupancy ratio of the character color in the area in the frame image in segments adjacent to front and rear ends of the high confident segment including credit title.

102. The credit-title segment detection program according to claim 99,
wherein: the telop-related feature quantity is display area information on the telop, and
the credit-title segment is judged by executing a telop detection process after weighting an area in the frame image specified by the display area information in segments adjacent to front and rear ends of the high confident segment including credit title.

103. A credit-title segment detection device for detecting a display segment of a credit title from video content, comprising:
input means for inputting video data of the video content;
search starting point determination means for determining a starting point which represents a temporal position for starting a credit-title search process based on an existence probability of a high character density part of the credit title in the credit-title segment; and
display segment judgment means for judging the display segment of the credit title by first executing the credit-title search process to the starting point and thereafter successively extending a segment as the target of the search process forward and backward from the starting point.
